(19) United States
(12) Patent Application Publication
(10) Pub. No.: US 2025/0166168 A1
(43) Pub. Date: May 22, 2025

(54) SYSTEMS AND METHODS FOR AUTOMATICALLY CHARACTERIZING PARTS AND SUPPORTING TECHNICIANS IN PERFORMANCE OF INSTALLATION, MAINTENANCE, REPAIR, AND INSPECTION TASKS

(71) Applicant: PartWorks, LLC, Atlanta, GA (US)

(72) Inventors: Scott Geller, Atlanta, GA (US); Dale Manning, Alexandria, VA (US); Maribeth G. Coleman, Atlanta, GA (US); Noah Posner, Atlanta, GA (US); Peter W. Presti, Atlanta, GA (US); Scott Robertson, Atlanta, GA (US); Benjamin Thompson, Atlanta, GA (US)

(73) Assignees: PartWorks, LLC, Atlanta, GA (US); Georgia Institute of Technology, Atlanta, GA (US)

(21) Appl. No.: 18/956,883

(22) Filed: Nov. 22, 2024

Related U.S. Application Data
(60) Provisional application No. 63/601,918, filed on Nov. 22, 2023.
(60) Provisional application No. 63/706,990, filed on Oct. 14, 2024.

(51) Int. Cl. G06T 7/00; G06T 7/73; G06T 7/80; G06V 10/75

(52) U.S. Cl. CPC G06T 7/001; G06T 7/74; G06T 7/80; G06V 10/757; G06T 2200/24; G06T 2207/30164; G06T 2207/30204; G06T 2207/30244; G06V 2201/06

(57) ABSTRACT

A system for facilitating the inspection of a structural part includes a processor and a non-transitory memory containing computer-readable instructions. When the computer-readable instructions are executed by the processor, the processor automatically identifies, in one or more images captured by a camera, one or more landmarks on a structural part. Additionally, the processor automatically evaluates a state of the one or more identified landmarks and presents, on a display, information concerning the evaluated state of the one or more identified landmarks for assisting a user of the display in performing an inspection of the structural part.

### CROSS-REFERENCE TO RELATED APPLICATION(S)

This application claims the benefit of and priority to U.S. Provisional Application No. 63/601,918 filed Nov. 22, 2023, and U.S. Provisional Application No. 63/706,990 filed Oct. 14, 2024, each of which is hereby incorporated herein by reference in its entirety for all purposes.

### STATEMENT REGARDING FEDERALLY SPONSORED RESEARCH

The subject invention was made with government support under Grant No. FA8650-21-C-5230 Amendment P00001 awarded by the Air Force Research Laboratory. The government has certain rights in this invention.

### FIELD

This disclosure relates generally to systems and methods to automatically characterize parts and support technicians in their tasks.

### BACKGROUND

Many AR systems exist to support maintenance and repair. However, they depend on existing 3D models or a phase for acquiring the 3D model of the part as well as complex real-time position tracking systems to support live augmentation. Furthermore, they are unable to recognize landmarks (e.g., holes, cracks, fasteners, scratches, edges of parts or features thereof such as windows, or other types of damage to or features of a part) at a small enough or precise enough scale (sub one to two inches) to be useful. Similarly, such systems require active indoor GPS, laser-based or other similar types of location-based tracking systems built into the tools used by the technician. We have created a light-weight system that is based on one or more printed 2D images to be placed in the scene, not requiring a lengthy setup nor calibration phase. It is also novel that we have a hybrid system that uses computer vision-based automation to reduce the workload of the technician while allowing some simple user inputs to overcome the shortcomings of computer vision automation deployed in a dynamic setting such an aircraft hangar, where the environment is unstable (e.g., shaking due to aircraft flying over) and where workpieces are moved in and out more frequently than in a production environment, along with ambient lighting sources and technician locations subject to frequent change.

### SUMMARY

In some embodiments, the system includes a processor and a non-transitory memory containing computer-readable instructions that, when executed by the processor, causes the processor to automatically identify, in one or more images captured by a camera, one or more landmarks on a structural part, automatically evaluate a state of the one or more identified landmarks, and present, on a display, information concerning the evaluated state of the one or more identified landmarks for assisting a user of the display in performing an inspection of the structural part.

In some embodiments, the one or more landmarks on the structural part include at least one of a structural component of the structural part, a geometric shape on the structural part, contours of the structural part, edges of the structural part, visual indicia of damage to the structural part, fasteners installed in the structural part, and holes in the structural part for receiving fasteners.

In some embodiments, automatically identifying the one or more landmarks on the structural part includes the processor: obtaining, from a database, an identification and corresponding location of landmark(s) stored in the database in association with the specific structural part; processing a portion(s) of the one or more images captured by the camera corresponding to the location(s) to determine whether the landmark(s) is present in those portions.

In some embodiments, processing the portion(s) of the one or more images captured by the camera corresponding to the location(s) to determine whether the landmark(s) is present in those portions includes the processor: obtaining, from the database, one or more stored images of the specific structural part having the identified landmarks at the obtained locations; and comparing portions of the obtained image(s) to the corresponding portions of the one or more images captured by the camera.

In some embodiments, processing the portion(s) of the one or more images captured by the camera corresponding to the location(s) to determine whether the landmark(s) is present in those portions includes the processor: obtaining, from the database, one or more stored images of the type(s) of landmark(s) identified as being associated with the specific structural part; and comparing the one or more obtained images of the type(s) of landmark(s) to portions of the one or more images captured by the camera to identify whether landmarks of the same type are present in the portions.

In some embodiments, obtaining, from the database, the identification and corresponding location of landmark(s) stored in the database in association with the specific structural part includes the processor processing the one or more images captured by the camera to locate a unique identifier affixed to and associated with the specific structural part.

In some embodiments, obtaining, from the database, the identification and corresponding location of landmark(s) stored in the database in association with the specific structural part includes identifying an arrangement of landmarks on the specific structural part and comparing the identified arrangement to those shown in images of structural parts stored in the database to identify a match.

In some embodiments, the processor is further configured to automatically store, in the database in association with the specific structural part, at least one of a type, location, and presence of the one or more landmarks on the structural part as identified.

In some embodiments, automatically identifying the one or more landmarks on the structural part includes the processor: receiving, from one or more sensors associated with the camera, information concerning an orientation of the camera and a distance of the camera from the structural part for each image captured by the camera; identifying, in a database of images, those database images which were captured from the same or similar orientation and distance as those of the one or more images captured by the camera; and comparing the one or more images captured by the camera to the identified database images to identify the one or more landmarks.

In some embodiments, the system includes the processor: identifying, in the one or more images captured by the camera, a fiducial affixed to the structural part; retrieving, from a database, dimensions of the identified fiducial; and using the retrieved dimensions of the fiducial as a reference to determine the distance of the camera from the structural part.

In some embodiments, automatically identifying the one or more landmarks on the structural part includes the processor: causing the display to display the one or more images captured by the camera; and receiving, from a user interface associated with the display, user input defining one or more portions of the structural part in which to automatically identify the one or more landmarks.

In some embodiments, automatically evaluating the state of the one or more identified landmarks includes the processor measuring, in the one or more images captured by the camera, at least one parameter of the one or more identified landmarks.

In some embodiments, automatically evaluating the state of the one or more identified landmarks further includes the processor determining whether any of the one or more measured parameters of the landmark exceed a predetermined threshold associated with the landmark.

In some embodiments, the landmark is a hole for receiving a fastener; wherein the one or more measured parameters include an internal diameter of the hole; and wherein the predetermined threshold is a maximum hole diameter.

In some embodiments, the landmark is a hole for receiving a fastener; wherein the one or more measured parameters include: (i) a distance from a center of the hole to an edge of the structural part, and (ii) an internal diameter of the hole; further including the processor calculating an edge distance of the hole as the ratio of (i) over (ii); and wherein the predetermined threshold is a minimum edge distance.

In some embodiments, the system includes the processor: identifying, in the one or more images captured by the camera, a fiducial affixed to the structural part; retrieving, from a database, dimensions of the identified fiducial; and using the retrieved dimensions of the fiducial as a reference to determine the one or more dimensions of the identified landmark and/or the distance of the identified landmark from other landmarks on the structural part.

In some embodiments, the processor is further configured to automatically store, in the database in association with the specific structural part, the information concerning the evaluated state of the one or more landmarks.

In some embodiments, presenting, on the display, information concerning the evaluated state of the one or more identified landmarks for assisting a user of the display in performing the inspection of the structural part includes overlaying the information on a transparent screen of a mobile device such that the overlaid information is positioned over or proximate to each corresponding landmark in the user's field of view.

In some embodiments, presenting, on the display, information concerning the evaluated state of the one or more identified landmarks for assisting a user of the display in performing the inspection of the structural part includes overlaying the information on a real-time image captured by the camera such that the overlaid information is positioned over or proximate to each corresponding landmark in the real-time image.

In some embodiments, presenting, on the display, information concerning the evaluated state of the one or more identified landmarks for assisting a user of the display in performing the inspection of the structural part the structural part includes displaying a visual indicator as to whether one or more of the evaluated parameters exceeds the associated predetermined threshold.

In some embodiments, the system includes a processor and a non-transitory memory containing computer-readable instructions that, when executed by the processor, causes the processor to automatically identify, in one or more images captured by a camera: one or more landmarks on a structural part and a tool, automatically obtain, from the tool, information concerning an operation performed by the tool in connection with the one or more identified landmarks, and automatically associate the information concerning the operation performed by the tool with the identified landmark on which the operation was performed.

In some embodiments, the one or more landmarks on the structural part include at least one of a structural component of the structural part, a geometric shape on the structural part, contours of the structural part, edges of the structural part, visual indicia of damage to the structural part, fasteners installed in the structural part, and holes in the structural part for receiving fasteners.

In some embodiments, automatically identifying the one or more landmarks on the structural part includes the processor: obtaining, from a database, an identification and corresponding location of landmark(s) stored in the database in association with the specific structural part; processing a portion(s) of the one or more images captured by the camera corresponding to the location(s) to determine whether the landmark(s) is present in those portions.

In some embodiments, processing the portion(s) of the one or more images captured by the camera corresponding to the location(s) to determine whether the landmark(s) is present in those portions includes the processor: obtaining, from the database, one or more stored images of the specific structural part having the identified landmarks at the obtained locations; and comparing portions of the obtained image(s) to the corresponding portions of the one or more images captured by the camera.

In some embodiments, processing the portion(s) of the one or more images captured by the camera corresponding to the location(s) to determine whether the landmark(s) is present in those portions includes the processor: obtaining, from the database, one or more stored images of the type(s) of landmark(s) identified as being associated with the specific structural part; and comparing the one or more obtained images of the type(s) of landmark(s) to portions of the one or more images captured by the camera to identify whether landmarks of the same type are present in the portions.

In some embodiments, obtaining, from the database, the identification and corresponding location of landmark(s) stored in the database in association with the specific structural part includes the processor processing the one or more images captured by the camera to locate a unique identifier affixed to and associated with the specific structural part.

In some embodiments, obtaining, from the database, the identification and corresponding location of landmark(s) stored in the database in association with the specific structural part includes identifying an arrangement of landmarks on the specific structural part and comparing the identified arrangement to those shown in images of structural parts stored in the database to identify a match.

In some embodiments, the processor is further configured to automatically store, in the database in association with the specific structural part, at least one of a type, location, and presence of the one or more landmarks on the structural part as identified.

In some embodiments, automatically identifying the one or more landmarks on the structural part includes the processor: receiving, from one or more sensors associated with the camera, information concerning an orientation of the camera and a distance of the camera from the structural part for each image captured by the camera; identifying, in a database of images, those database images which were captured from the same or similar orientation and distance as those of the one or more images captured by the camera; and comparing the one or more images captured by the camera to the identified database images to identify the one or more landmarks.

In some embodiments, the system includes the processor: identifying, in the one or more images captured by the camera, a fiducial affixed to the structural part; retrieving, from a database, dimensions of the identified fiducial; and using the retrieved dimensions of the fiducial as a reference to determine the distance of the camera from the structural part.

In some embodiments, automatically identifying the one or more landmarks on the structural part includes the processor: causing the display to display the one or more images captured by the camera; and receiving, from a user interface associated with the display, user input defining one or more portions of the structural part in which to automatically identify the one or more landmarks.

In some embodiments, automatically identifying the tool includes the processor: obtaining, from the database, one or more stored images of tools; comparing the one or more obtained images tools to the one or more images captured by the camera to identify a tool present in the one or more images.

In some embodiments, automatically identifying the tool includes the processor processing the one or more images captured by the camera to locate a unique identifier affixed to and associated with the tool.

In some embodiments, automatically obtaining, from the one or more tools, information concerning an operation performed by the identified tool in connection with the one or more identified landmarks includes the processor causing a receiver to establish a signal connection with the identified tool based on the unique identifier on the identified tool, the signal connection being suitable for at least receiving the information transmitted by the identified tool.

In some embodiments, automatically associating the information concerning the operation performed by the tool with the identified landmark on which the operation was performed includes: receiving, together with the obtained information regarding the operation performed by the tool, a time stamp corresponding to when the operation was performed; determining, based on the received time stamp, a location of the tool in the one or more images captured by the camera at the time indicated by the received time stamp; comparing the determined location of the tool to a location of the one or more landmarks identified in the one or more images captured by the camera at the time indicated by the received time stamp to determine the identified landmark on which the the tool was performing the operation.

In some embodiments, automatically associating the information concerning the operation performed by the tool with the identified landmark on which the operation was performed includes: detecting, in the one or more images captured by the camera, the operation being performed using the tool; determining, either upon such detection or based on a time stamp generated in connection with such detection, a location of the tool in the one or more images captured by the camera at the time the operation was performed; comparing the determined location of the tool to a location of the one or more landmarks identified in the one or more images captured by the camera at the time the operation was performed to determine the identified landmark on which the the tool was performing the operation.

In some embodiments, the processor is further configured to automatically store, in the database in association with the structural part, the information concerning the operation performed by the tool in association with the identified landmark on which the operation was performed.

In some embodiments, the system includes the processor determining whether any of the information concerning the operation performed by the tool exceeds a corresponding predetermined threshold associated with the operation.

In some embodiments, the predetermined threshold associated with the operation depends at least in part on an evaluation of the state of the landmark conducted prior to performing the operation.

In some embodiments, the landmark is a hole in the structural part for receiving a fastener; wherein the tool is a tool configured for expanding the fastener within a hole in the structural part; wherein the evaluation of the state of the hole conducted prior to performing the operation includes measuring an inner diameter of the hole; and wherein the predetermined threshold associated with the operation is a maximum degree of expansion associated with a maximum permissible hole diameter.

In some embodiments, the processor is further configured to present, on a display, the information concerning the operation performed by the tool for assisting a user of the display in performing one or more installation, maintenance, repair, or inspection tasks on the structural part

In some embodiments, presenting includes overlaying the information concerning the operation performed by the tool on a transparent screen of a mobile device such that the overlaid information is positioned over or proximate to the identified landmark on which the operation was performed in the user's field of view.

In some embodiments, presenting includes overlaying the information concerning the operation performed by the tool on a real-time image captured by the camera such that the overlaid information is positioned over or proximate to the identified landmark on which the operation was performed in the real-time image.

In some embodiments, presenting includes displaying a visual indicator as to whether any of the information concerning the operation performed by the tool exceeds the associated predetermined threshold.

In some embodiments, the system includes a processor, and a non-transitory memory containing computer-readable instructions that, when executed by the processor, causes the processor to automatically determine a three-dimensional position and orientation of a camera relative to a structural part within a field of view of the camera, automatically identify, in a two-dimensional image captured by the camera, one or more landmarks on the structural part, wherein automatically identifying the one or more landmarks includes: accessing, from a database of reference images, one or more reference images of reference landmarks which were captured from the same or similar relative three-dimensional position and orientation of the camera, and identifying, in the two-dimensional image, one or more portions of the two-dimensional image matching at least one of the accessed reference images. automatically evaluate a state of the one or more identified landmarks, and present, on a display, information concerning the evaluated state of the one or more identified landmarks for assisting a user of the display in performing an inspection of the structural part, the presented information being overlaid on the one or more identified and evaluated landmarks shown in the two-dimensional image.

In some embodiments, the one or more landmarks on the structural part include at least one of a structural component of the structural part, a geometric shape on the structural part, contours of the structural part, edges of the structural part, visual indicia of damage to the structural part, fasteners installed in the structural part, and holes in the structural part for receiving fasteners.

In some embodiments, automatically determining the three-dimensional position and orientation of the camera relative to a structural part within a field of view of the camera includes the processor: identifying, in the two-dimensional image, a fiducial affixed to the structural part, the fiducial having a known size and shape; and calculating, based on the known size and shape of the fiducial, the three-dimensional position and orientation of the camera relative to the structural part.

In some embodiments, automatically identifying the one or more landmarks on the structural part includes the processor: causing the display to display the two-dimensional image; and receiving, from a user interface associated with the display, user input defining one or more portions of the structural part in which to automatically identify the one or more landmarks.

In some embodiments, automatically evaluating the state of the one or more identified landmarks includes the processor: measuring, in the two-dimensional image captured by the camera, at least one parameter of the one or more identified landmarks; and transforming the parameter measurement to account for the perspective of the camera based on the determined three-dimensional position and orientation of the camera relative to the structural part.

In some embodiments, transforming the measured parameter includes: deriving, from the determined position and orientation of the camera relative to the structural part, an angle at which the two-dimensional image was captured by the camera; and calculating, based on the derived angle, a corresponding adjustment to the measured parameter.

In some embodiments, automatically evaluating the state of the one or more identified landmarks further includes the processor determining whether any of the one or more measured parameters of the landmark, as transformed to account for the perspective of the camera, exceed a predetermined threshold associated with the landmark.

In some embodiments, the non-transitory memory further includes computer-readable instructions that, when executed by the processor, causes the processor to: automatically identify a tool in the two-dimensional image; automatically obtain, from tool, information concerning an operation performed by the tool in connection with the one or more identified landmarks; and automatically associate the information concerning the operation performed by the tool with the identified landmark on which the operation was performed.

In some embodiments, automatically associating the information concerning the operation performed by the tool with the identified landmark on which the operation was performed includes: automatically determining a three-dimensional position and orientation of the tool relative to the structural part; and identifying, based at least in part on the determined three-dimensional position and orientation of the tool relative to the structural part, the landmark with which the tool is interacting when performing the operation.

In some embodiments, automatically determining the three-dimensional position and orientation of the tool relative to the structural part includes the processor: identifying, in the two-dimensional image, a first fiducial affixed to the tool and a second fiducial affixed to the structural part, each of the first and second fiducials having a known size and shape; and calculating, based on the known sizes and shapes of the first and second fiducials, the three-dimensional position and orientation of the tool relative to the structural part includes the processor.

### BRIEF DESCRIPTION OF THE DRAWINGS

References are made to the accompanying drawings that form a part of this disclosure and that illustrate embodiments in which the systems and methods described in this Specification can be practiced.

FIG. 1 is a schematic diagram of a system, according to some embodiments.

FIG. 2 is an XR system, according to some embodiments.

FIG. 3 is a camera and light system, according to some embodiments.

FIG. 4A and FIG. 4B show an embodiment in which the system can read unique identifiers affixed to various types of fasteners and notify a technician whether that particular fastener is the correct one to be used on that particular part., according to some embodiments.

FIG. 5 is a display of an XR system, according to some embodiments.

FIG. 6 is a tool for use in the system, according to some embodiments.

FIG. 7 is a tool for use in the system, according to some embodiments.

FIG. 8 is a table of data from a tool for use in the system, according to some embodiments.

FIG. 9 is a display of an XR system, according to some embodiments.

FIG. 10 is a display of a system, according to some embodiments.

FIG. 11A and FIG. 11B illustrates a camera having a rigid tube structure protruding

forward of the lens, according to some embodiments.

FIG. 12 illustrates an elastomeric platform.

FIG. 13 illustrates a type of 3D camera.

Like reference numbers represent the same or similar parts throughout.

### DETAILED DESCRIPTION

Embodiments of the present disclosure are directed to systems and methods for automatically identifying and evaluating landmarks on parts and supporting technicians in performance of various tasks such as installation, maintenance, repair, and inspection tasks. Generally speaking, systems and methods of the present disclosure combine computer vision, artificial intelligence, and extended reality (XR) technologies to automatically identify and display information relevant to a task at hand within a field of view of a user, thereby promoting efficiency, quality work, the documentation of work performed, and other benefits. The present disclosure often describes these systems, methods, and benefits in the context of tasks like installing fasteners in aircraft parts; however, it should be recognized that there is far broader applicability across industries and particular tasks.

In some embodiments, this system can be for use with parts that have features requiring installation, inspection, maintenance, or repair. Features of a part, in some embodiments, can include structural components or geometric shapes (e.g., slats, holes, fasteners) and/or various types of damage (e.g., cracks, scratches). The system can, in some embodiments, be capable of functioning in the absence of 3D models or any other knowledge about the location of the features by virtue of its use of computer vision. Computer vision, in some embodiments, can be used to identify the features as well as various other landmarks on the part (e.g., edges of parts or other visually distinctive aspects thereof, such as contours (e.g., recessions or protrusions) and components like openings, windows, handles, and the like; holes or fasteners in the part). In some embodiments, landmarks include at least one of a structural component of the structural part, a geometric shape on the structural part, contours of the structural part, edges of the structural part, visual indicia of damage to the structural part, fasteners installed in the structural part, and holes in the structural part for receiving fasteners. These landmarks may be useful for identifying the part, helping to locate and identify the features of interest to a technician during a particular inspection/maintenance/repair task, for evaluating whether a given feature requires further attention (e.g., a hole's edge distance is out of spec, a hole may not meet requirements defined by a manufacturer, or some other item of interest can be flagged as a result of the landmark, or any combination thereof, as will be later described in more detail), or any combination thereof.

For the sake of simplicity, the terms “features” and “landmarks” can, at times, be used interchangeably throughout the present disclosure since features are often optically identifiable landmarks on the part. Accordingly, the term “landmark 12” may be used throughout the present disclosure to refer to features and landmarks, either collectively or individually as surrounding context would suggest.

Generally speaking, during the “landmark identification” phase the system can use computer vision (optionally in collaboration with manual input from the technician) to locate the 3D location of landmarks on the part and store it in a database. If a database already exists, the system can use a similar hybrid technique to correct the database if changes are detected, such as new landmarks, or resized landmarks. For example, if the landmark had been previously identified, the database can be analyzed and updated. In some embodiments, the system, based on the updated landmark information or in view thereof, can provide further instructions to the technician, including capturing more information about the updated landmark. In the “evaluation” phase the technician may use tools to evaluate the state of the identified landmarks, such as by determining and/or measuring geometric properties of the identified landmarks (e.g., assessing eccentricity, measuring circularity, measuring roundness, measuring diameter, measuring distances from other landmarks) and/or light-based properties of the identified landmarks (e.g., coloration, reflectivity, especially but without limitation those associated with the state of the landmark material such as oxidation, corrosion, etc.). In some embodiments, a fiducial on a tool may allow the system to track which landmark is interacted with and capture data from the tool directly. Once the technician has determined, based on the evaluation phase, whether any further tasks (e.g., maintenance, repairs) are needed, they enter the “task” phase. The technician, in some embodiments, may use a tracked tool(s) to perform the task. This allows the system to track the 3D location of the tool and, as a result, it can provide real-time job aids/feedback to the technician and to store data about the task in the database. This same system can be used during a subsequent “inspection” phase to review the task data in situ. In all phases, the 3D landmark data, along with the real time tracking of parts and tools, allows for an augmented reality presentation of data and job aid content if needed.

### System 100

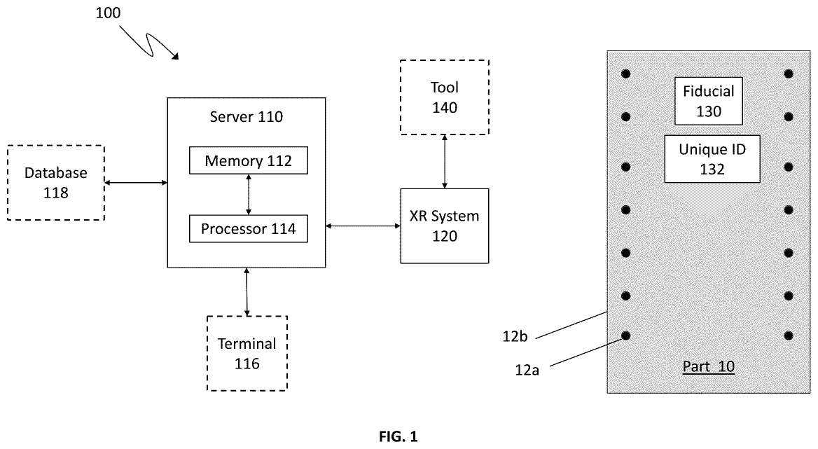

FIG. 1 is a schematic view of a representative system 100 for performing any one or combination of the methods described herein. System 100, in various embodiments, may include a server 110 and an XR system 120. Optionally, in some embodiments, a unique identifier 132 affixed to a part 10 can be used to (i) help identify the part, (ii) pull up relevant information about the part from a database 118 in communication with server 110. Additionally or alternatively, one or more fiducials 130 may be affixed to the part to help calibrate XR system 120 to the respective dimensions of the part 10 and landmarks 12 thereof, so as to facilitate system 100 in (i) identifying landmarks 12 (shown here as holes 12a and part edges 12b), (ii) making precise measurements using captured imagery and other data, and (iii) performing computations necessary to accurately overlaying these landmark identifications and associated information onto a 2D image of the part 10 as captured by XR system 120 for display to a technician. Further, one or more tools 140 may optionally, in some embodiments, be integrated with other components of system 100 to facilitate technicians in performing present and future tasks (e.g., inspection, maintenance, repair tasks or any combination thereof). The foregoing are described in more detail throughout the present disclosure.

### Server 110

System 100, in various embodiments, may generally comprise at least one server 110 comprising at least one non-transitory memory 112 containing computer-readable instructions for performing methods of the present disclosure and at least one processor 114 configured to read and execute the computer-readable instructions stored on memory 112. Server 110, in some embodiments, can be a local server or remote server (e.g., cloud server) configured to send and receive information, requests, instructions, or some combination thereof to and from other components of system 100 via one or more wired or wireless communications links. While the present disclosure refers to memory 112 and processor 114 as being part of a server, it should be recognized that memory 112 and processor 114 can be stand alone or be housed in or with any other hardware suitable for permitting memory 112 and processor 114 to store and execute, respectively, computer-readable instructions for performing various methods described herein and thus the present disclosure should not be limited to any one particular hardware embodiment of server 110, memory 112, and processor 114.

Server 110, in various embodiments, can, in some embodiments, comprise at least one user terminal 116 comprising a graphical user interface (GUI) through which persons may monitor and interact with server 110 and other components of system 100 therethrough. User terminal 116, in some embodiments, can comprise a desktop, a laptop computer, a mobile device (e.g., smartphone, tablet), or some combination thereof, for example, with the GUI comprising a display and one or more input devices such as a touchscreen, mouse, keyboard, and/or other peripherals. User terminal 116, in some embodiments, can be configured to allow a manager to remotely (and/or locally) inspect work performed by a technician. For example, user terminal 116 can permit a manager to view the work, in real time, being performed by the technician. As one can appreciate, as a technician inspects various parts, other interested parties may want to view that inspection as it is occurring or soon thereafter to ensure compliance, adherence to requirements, or to identify landmarks that may have been recently identified as problematic. Additionally, in some embodiments, remote inspection can permit a manager to inspect the work perform by a new technician for training purposes.

In some embodiments, server 110, can include one or more database 118 for storing data and other information to be used by processor 114, other components of system 100, or some combination thereof in executing the methods disclosed herein. For example, the one or more database 118, in some embodiments, can store information relating to various parts 10 which can include information regarding associated landmarks 12 associated therewith (sometimes referred to herein as a “landmark database”). For example, the one or more database 118 can include a progression of the associated landmarks 12, over time, to show the user the relative change in the associated landmark 12 since it was first identified. Additionally or alternatively, the one or more database 118 can include the intended locations of landmarks 12 during manufacturing or initial assembly of part 10. As further described below, server 110 may access such landmark information for a given part 10 for use in generating the XR displays and other functionality described herein.

### XR System 120

System 100, in various embodiments, may include an XR system 120 for capturing and displaying XR information in a field of view of a user. To that end, XR system 120 can include (i) a display 122 configured to display the XR information, such as the display of a head-mounted XR headset or a smartphone/tablet, and (ii) one or more cameras 124 directed at part 10 to capture one or more images for display on display 122 and/or for processing by computer vision software installed remotely on server 110 and/or locally on XR system 10.

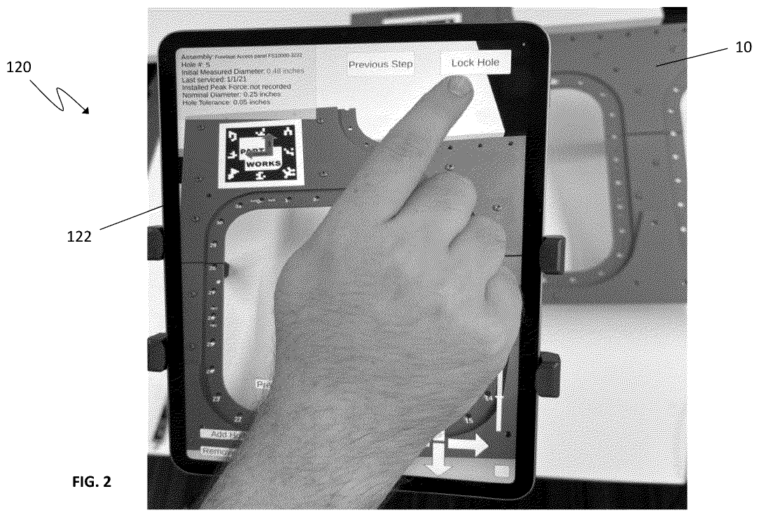

In some embodiments, at least one of camera(s) 124 can be combined with display 122 in a single device (e.g., a camera-equipped smartphone/tablet/XR headset). Combining at least one of camera(s) 124 with display 122 in a single device can, in some embodiments, allow for: (i) use of a non-transparent display 122 and/or (ii) capturing imagery from perspectives and distances not otherwise captured by separate fixed-position camera(s) 124 mounted elsewhere in the room. For example, when a field of view of the user would otherwise be blocked by such a non-transparent display, the integral camera(s) 124 can capture the blocked portion of the user's field of view and display it to the user on display 122. In some embodiments, additional XR information (e.g., that called from database 118 and/or that processed by the computer vision software using imagery captured by the integral camera(s) 124 and separate camera(s) 124, if XR system 120 is so equipped) can also be overlayed on the displayed field of view imagery on device 122. Both the blocked field of view and additional XR data overlay can be viewed in the embodiment shown in FIG. 2 with the integral camera 124 on the back side of the tablet and pointed at part 10.

As later described in more detail, in some embodiments, the computer readable instructions can cause the at least one processor 114 to, when executed by the at least one processor 114, to automatically identify, in one or more images captured by the at least one camera 124, one or more landmarks on a structural part. For example, the at least one processor 114 can obtain, from the database 118, an identification and corresponding location of the landmark 12 which can be stored within the database 118 in association with a specific structural part 10. The at least one processor 114 can, in some embodiments, process at least one portion of the one or more images captured by the at least one camera 124 corresponding to the location(s) to determine whether the at least one landmark 12 can be present in those portions of the image. In some embodiments, the at least one processor 114 can compare at least one portion of the one or more image obtained from the database 118 to the corresponding at least one portion of the one or more image captured by the at least one camera 124.

When processing the portion(s) of the one or more images captured by the camera corresponding to the locations to determine whether the landmark(s) 12 is present in those portions, the at least one processor 114 can, in some embodiments, obtain one or more stored images of the type(s) of landmark(s) 12 identified as being associated with the specific structural part 10. For example, after obtaining the one or more images of the type(s) of landmark(s) 12 associated with the specific structural part 10, the processor 114 can compare the one or more obtained images to the type(s) of landmark(s) 12 to portions of the one or more images captured by the camera to identify whether landmark(s) 12 of the same type are present in the portions. For example, the processor 114 can analyze the portion of the image stored in the database 118 to that same portion in an image captured by the camera 124 to identify whether the identified landmark(s) 12 are present in both portions. In some embodiments, the at least one processor 114 can be configured to automatically store in the database 118, in association with a specific structural part 10, information concerning the evaluated state of the one or more landmarks 12. For example, the at least one processor 114 can store information relating to the evaluation of landmarks 12 in the database 118 for remote retrieval, for future access and comparison by the at least one processor 114, for other analysis on the landmark 12, or some combination thereof.

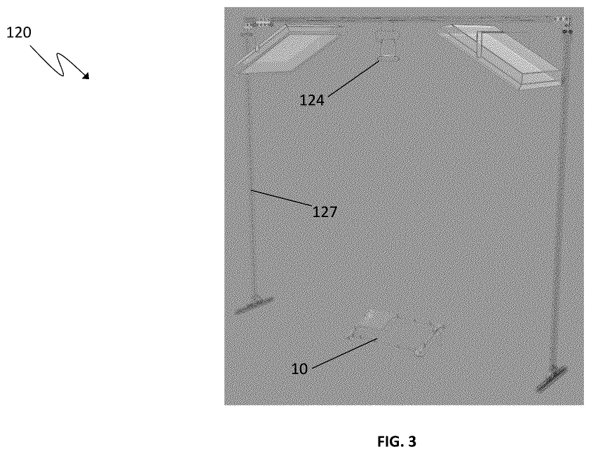

In some embodiments, at least one of camera(s) 124 can be physically separate from display 122. For example, the embodiment shown in FIG. 3 shows a workbench environment with a frame 127 configured to support camera 124 and lights at a fixed distance from the surface of a part 10 that has been removed from an aircraft being inspected, maintained, repaired, or some combination thereof. Imagery captured by separate camera(s) 124 can be evaluated by computer vision algorithms on server 110 (or locally on XR system 120 and/or on camera(s) 124 or other hardware; i.e., an edge computing solution) and information derived therefrom (e.g., the locations of landmarks 12) transmitted to and displayed on display 122, as further described below. In some embodiments, the imagery captured by the separate camera(s) 124 can be uploaded to the one or more database 118 and associated with the part 10, with the associated landmark 12, or some combination thereof, as relevant.

In some embodiments, the at least one processor 114 can receive from one or more sensors associated with the at least one camera(s) 124 additional information concerning an orientation of the camera and a distance of the camera from the structural part 10 for each image captured by the camera(s) 124. For example, the at least one processor 114 can receive, in addition to the images from the at least one camera(s) 124, information relating to the position of the at least one camera(s) 124 relative to the part 10. In some embodiments, the one or more sensors associated with the at least one camera(s) 124 can include an accelerometer. In some embodiments, the at least one processor 114 can identify from the database 118 of images, those database 118 images which were captured from the same or similar orientation and distance as those of the one or more images captured by the camera 124 to compare the one or more images captured by the camera 124 to the identified database images to identify the one or more landmarks 12. For example, the at least one processor 114 can compare images with similar camera 124 orientation and distance from the part 10 when the at least one processor 114 identifies the landmark 12, to improve the fidelity of the results.

For the sake of simplicity, all of the foregoing embodiments will be referred to as “XR system 120” herein regardless of whether display 122 is transparent vs. reproduces the users blocked field of view using an integral camera(s) 124, and regardless of whether camera(s) 124 are used in connection with the computer vision-related tasks described herein (e.g., identifying/locating landmarks 12 on part 10). In some embodiments, inertial information (e.g., the position/orientation information provided by an inertial measurement unit (IMU) associated with display 122) can be used to help the computer vision algorithm in recognizing landmarks 12, to help overlay information correctly in the XR display 122, or some combination thereof.

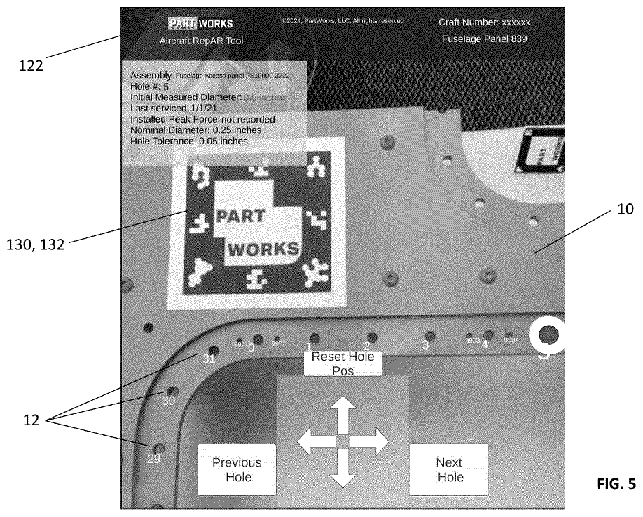

FIG. 5 illustrates an embodiment of an XR interface on display 122. In some embodiments, imagery captured by camera 124 can be displayed and overlaid with various information from various sources. Information regarding the aircraft and specific part 10 can be displayed for example in the upper right corner, the locations of various landmarks 12 as determined by computer vision can be overlaid on those landmarks (here, holes), and information regarding a selected landmark 12 (here, hole 5 as indicated by the wide circle surrounding that particular hole) can be displayed for example near the upper left corner. The latter information may have been stored in and pulled from database 118 as described herein. Interactive buttons (here, touchscreen activated) are shown near the bottom of display 122 for cycling between landmarks and other features available via the XR interface. It is to be appreciated that the system 100 that these locations are examples and the actual layout of the interface can vary beyond the stated examples according to the principles of this disclosure.

### Fiducial 130

Referring back to FIG. 1, system 100, in some embodiments, can include one or more fiducials 130. Fiducials 130, in some embodiments, may be affixed to one or more objects within the field of view of camera 124 and, by virtue of their known sizes and shapes, can provide information necessary for server 110 to determine the relative position and orientation of camera 124 to such object(s), as well as the positions and orientations of such objects relative to one another. Such information can, in turn, facilitate the accurate identification and/or precise evaluation of landmarks 12 on structural part 10, as further described herein. Such information may further help server 110 in determining which landmark 12 a tool 140 is interacting with so that, in turn, server 110 can automatically associate information concerning the operation performed by the tool 140 with the identified landmark 12 on which the operation was performed, as further described herein.

In one aspect, fiducial(s) 130, by virtue of their known sizes and shapes, may serve as a size reference scale for server 110 to use in measuring distances on structural part 10 and otherwise tracking landmarks 12 thereon. For example, if fiducial 130 is known to be 3 inches long by 2 inches wide, then server 110 may assume that objects in other portions of the image at a similar distance from camera 124 can be measured using that scale. Of course, not all objects may be a similar distance away from camera 124—in such cases, it may be helpful for additional fiducials to be affixed to those objects such that an accurate reference scale is used by server 110 when measuring distances on those objects. Further, camera 124 may not always be looking at a given object straight-on, but rather may be viewing that object from some sort of angle. In such cases, the known shape of fiducial 130 can be used to estimate such viewing angle and account for it when identifying and evaluating landmarks. For example, if fiducial 130 is circular but appears ovate in the image captured by camera 124, then server 110 may assume camera 124 is viewing fiducial 130 from a side angle and can determine, by geometric analysis, the degree of side angle based on the measured dimensions of the apparently-ovate fiducial 130, knowing that it is actually circular. The reference scale can then be adjusted accordingly to ensure accurate measurements are taken.

In another aspect, fiducial(s) 130, by virtue of their known sizes and shapes, may facilitate server 110 in identifying landmarks 12 on structural part 10. First, by serving as a size reference scale, accurate measurements of potential landmarks can be obtained and, in turn, used to help identify landmarks 12 based on their dimensions. For example, if server 110 determines that a feature of interest in the image may be a landmark 12, it can measure the dimensions of that feature and compare those to known measurements of possible landmarks it could be. Second, in providing the ability to determine the angle at which camera 124 is viewing structural part 10, fiducial 130 may enable server 110 to rely on reference images of landmarks taken at the same or similar angle when trying to decipher whether a feature of interest in the image captured by camera 124 is a landmark and, if so, what kind. Continuing the example above, say server 110 is analyzing an image of a part 10 for possible fastener holes. If server 110 knows that camera 124 is viewing structural part 10 from a particular side angle, then server 110 may access, from a database of reference images, one or more reference images of fasteners known to have been captured from the same or similar side angle. As noted above, a round fastener may appear ovate when viewed from a side angle so, as equipped with reference images known to have been taken from the same or similar perspective, server 110 may identify fasteners more quickly and reliably than if only using head-on images of fasteners as reference images. Stated otherwise, server 110 may identify, in the two-dimensional image captured by camera 124, one or more portions of the two-dimensional image matching at least one of the accessed reference images and thereby provide a positive identification of such landmark 12.

In yet another aspect, fiducial(s) 130, by virtue of their known sizes and shapes, can facilitate server 110 in correctly overlaying information about each landmark 12 (e.g., from evaluating the state of such landmarks such as dimensions, coloration, whether those dimensions or coloration exceed predefined thresholds) on top of the corresponding landmarks 12 shown in the image (and subsequent images) captured by camera 124. Simply stated, fiducial(s) 130 may allow for determining the position and orientation of camera 124 relative to structure 10 as previously described and, as such, provide server 110 with the capability to determine if camera 124 has moved position and/or reoriented since, such that the necessary reference frame transformations can be performed to know exactly where landmarks 12 identified in a first image are now positioned in a second, subsequent image. Now the information regarding each landmark 12 can be properly overlaid on the subsequent image without necessarily having to go through the process of re-identifying the landmarks 12 in the subsequent image.

In still another aspect, fiducial(s) 130, by virtue of their known sizes and shapes, can facilitate server 110 in identifying interactions between objects within its field of view. In some embodiments, a first fiducial 130 may be affixed to structural part 10 and a second fiducial may be affixed to a tool 140. Using the principles described above, server 110 can determine the position and orientation of tool 140 relative to structural part 10 and thereby determine the particular landmark 12 on structural part 10 with which the tool 140 is interacting. As previously noted, this can allow server 110 to then associate information concerning the operation of that tool 140 with that particular landmark 12 and store it in database 118.

In some embodiments, fiducial(s) 130 can be an optical marker, a marker identifiable by the camera(s) 124, a marker that can be visualizable or de-coded by the camera(s) 124 to translate proprietary or confidential information to the user from a part that is publicly viewable, or some combination thereof. It is to be appreciated that the system can be adapted to use other types of markers without departing from the principles of this disclosure. In some embodiments, the database 118 can store dimensions of the fiducial 130 for later analysis by the at least one processor 114. For example, the at least one processor 114 can identify a fiducial 130 affixed to a structural part 10 in an image captured by the camera 124. The at least one processor 114 can retrieve from the database 118 the dimensions of the identified fiducial 130 and can use the retrieved dimensions of the fiducial 130 as a reference to determine additional information about the part 10, the landmark 12, positional relationship between multiple landmarks 12, positional information (i.e., orientation and/or distance) of the camera 124, or some combination thereof. For example, the at least one processor 114 can use the retrieved dimensions of the fiducial 130 as a reference to determine the one or more dimensions of the identified landmark 12 and/or the distance of the identified landmark 12 from other landmarks 12 on the structural part 10.

In various embodiments, a fiducial 130 may be placed on the part 10 and on any tools 140/devices/accessories that must be tracked by the system 100 (meaning their 3D location (x,y,z) and pose (pitch, yaw, roll) is being calculated and utilized by the program). A camera 124, which as described elsewhere in this disclosure, could be part of the viewing device, like a tablet, or it could be external to the viewing device, may be pointed at the scene such that one or more of the fiducials 130 is in view. The two-dimensional image from the camera 124 may be analyzed to calculate the camera's 124 three-dimensional position and pose (orientation) relative to the fiducial 130. From there the three-dimensional information may be ingested into the three-dimensional scene graph (the software, often a game engine, that keeps track of and renders the 3D virtual scene on the viewing device). This may also enable the system 100 to identify which physical objects are in the scene (e.g. which type of tool 140 is being used or the serial number of a part, assuming that information is encoded in the fiducial image). This may also allow the three-dimensional scene graph to keep track of where the tracked physical objects are in the scene and relative to each other and to virtual content. This, in turn, may enable the system 100 to render virtual three-dimensional content (e.g. virtual highlights around identified landmarks 12) as well as track the interactions of physical objects (e.g. detecting when a tool 140 approaches a landmark 12 on the physical part 10). Once tracking has begun (e.g. a fiducial 130 was seen in an image captured by the camera 124), even if all the fiducials 130 go out of view, tracking can continue through sensor fusion, meaning that sensors on the device (gyroscope, inertial, accelerometer, GPS etc.) or through analysis of the video frames (e.g. application of a Simultaneous Localization and Mapping (SLAM) algorithm) to continue to track the three-dimensional position and orientation of the device until a fiducial 130 comes back into view.

As noted above, additionally or alternatively, the relative three-dimensional positions and orientations of camera 124 and objects in the captured image can be determined using alternative methods. For example, in embodiments in which camera 124 is fixed the user could manually input the location and orientation of camera 124 relative to structural part 10. As another example, camera 124, in an embodiment, may be provided with an inertial measurement unit (IMU) or other sensors capable of providing information relevant to determining the position and/or orientation of camera 124 relative to other objects. Additionally or alternatively, in an embodiment, the objects of interest (e.g., structural part 10; tool 140) could likewise be equipped with similar sensors. That said, such approaches may be more complex and computationally intensive, and depending on the technology used, not as accurate (e.g., GPS positioning may not be precise enough).

### Unique Identifier 132

System 100, in some embodiments, can additionally or alternatively include one or more unique identifiers 132 configured for identifying a part 10, tool 140, component (e.g., a fastener to be installed on part 10), or other object to which the unique identifier 132 is affixed. Unique identifier may include any visual marker capable of being used in such a manner, such as a QR code or bar code. In some embodiments, the at least one processor 114 can process the images captured by the camera(s) 124 to locate a unique identifier 132, affixed to and associated with the specific structural part 10. In some embodiments, unique identifier 132 may be combined with fiducial 130 (e.g., as shown in FIG. 5) while, in other embodiments, unique identifier 132 may be a standalone marker.

In one aspect, unique identifier 132 can allow system 100 to call up information, from database 118 that can be relevant to the object to which the unique identifier 132 is affixed. For example, reading a unique identifier 132 affixed to part 10 may allow system 100 to pull up information stored in association with part 10, such as landmark 12 locations, information concerning prior inspections, maintenance, repairs, or other tasks performed on part 10. In some embodiments, that information can be displayed on display 122 to help a technician be more efficient and effective in performing a current task. Additionally or alternatively, in some embodiments, reading unique identifier 132 can provide for seamlessly ensuring information collected during a current task can be automatically stored to database 118 in association with that part 10.

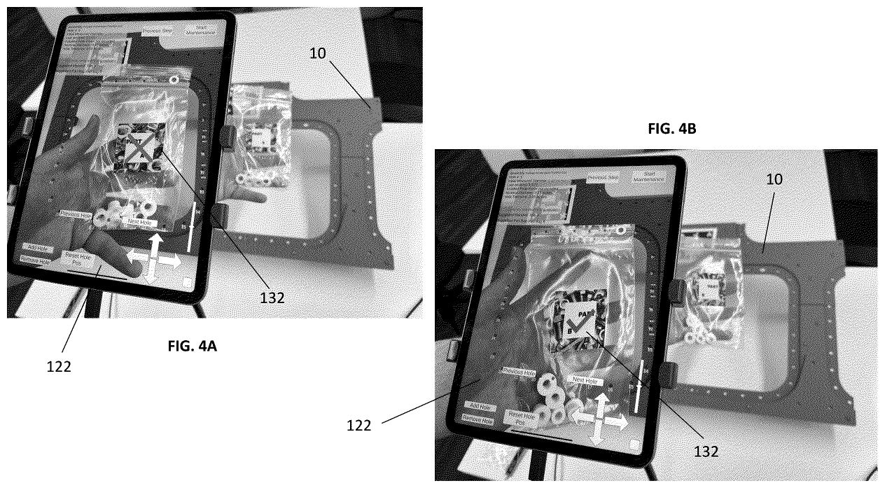

In another aspect, unique identifier 132 can enable system 100 to detect when a technician is installing (or has installed) the wrong component. For example, FIG. 4A and FIG. 4B show an embodiment in which system 100 can read unique identifiers 132 affixed to various types of fasteners and can notify the technician whether that particular fastener is the correct one to be used on that particular part 10. The red “X” shown on display 122 in FIG. 4A can indicate to the technician that they are about to use the wrong type of fastener, while the green “check mark” shown on display 122 in FIG. 4B indicates to the technician that they have the correct type of fastener. Similar functionality could be achieved using additional tools such as scanning guns or RFID readers; however, it would not be as seamless since the technician would ostensibly have to have such a tool on-hand, put down whatever they are holding to pick up it up, physically scan the component to be installed, and put the tool back down before continuing, whereas here the technician simply needs to have the component in the field of view of XR system 120.

In some embodiments, system 100 can read a unique identifier 132 affixed to an object and access, in database 118, instructions concerning a task to be performed in connection with that object. These instructions can then, in turn, be displayed to a technician via display 122.

As another example, recently a door plug on a commercial airliner blew out mid-flight causing the cabin to decompress and the pilot to initiate an emergency landing, all because four bolts that secure the plug were not reinstalled at the end of an associated maintenance task. In some embodiments, the system 100 can be configured to detect, based on not having detected the presence of unique identifiers 132 associated with each of those four bolts, that components like those bolts are missing. For example, the unique identifiers can be tracked by the system 100 such that the system 100 can be alerted by their presence in an incorrect location and, in addition, the system 100 can be alerted by the absence of a unique identifier 132 that the system 100 expects or determines should exist in a specific location. The system 100 can alert the technician that a job may not complete based on the absence of unique identifiers 132. One of ordinary skill in the art will recognize that computer vision could also perform all of the aforementioned functionality without the use of unique identifier 132 or otherwise uniquely-identifying fiducials 130 if sufficiently capable of identifying a specific part 10, tool 140, or component based on captured imagery alone, though the use of unique identifiers 132 may reduce errors and allow for less computationally-intensive computer vision to be utilized.

### Tool 140

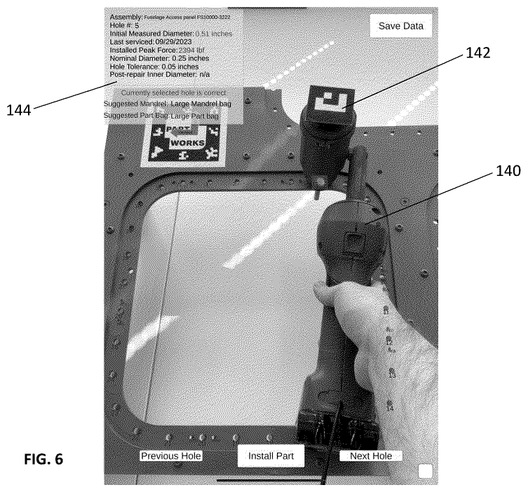

System 100, in various embodiments, may optionally further include one or more tools 140. Tool 140 can be any tool, instrument, or the like that can be used by a user in performing a task related to part 10. For example, as shown in FIG. 6, tool 140 may be a tool for installing fasteners in holes in aircraft parts and/or coldworking those holes as part of maintenance/repair tasks.

In some embodiments, an optical tracker 142 (in some embodiments, unique identifier 132 or fiducial 130) or other means for helping track the location of tool 140 can be affixed to tool 140 to assist server 110 in tracking the location of tool 140 relative to XR system 120 and part 10 (and landmarks 12 thereon). It should be recognized that the inclusion of the tool 140 in the system 100 can be optional since not all tasks benefitting from the functionality of the present systems and methods involve a tool. For example, an inspector can use the system 100 to verify that certain tasks were performed correctly—e.g., that a newly manufactured part 10 can include the correct number and arrangement of fastener holes as called for in the design specs. Such an inspection task can benefit from the ability to overlay required hole locations on the part to verify whether holes are actually present in each such location, and may not necessarily involve the use of any tools 140 by the inspector.

To allow for the attachment of optical trackers 142 to tools associated with the work, custom tracker mounts and fiducial designs were created and 3D printed for the puller and hole gauge tools, such that their position and orientation could be tracked when in use. In some embodiments, optical tracking solutions for the nut plate and mandrel accessories (placed in a bag in the current embodiment) can be used to double check that a user is using the correct components during the repair. We have performed tests of this tracking approach and interactions with the tools and accessories.

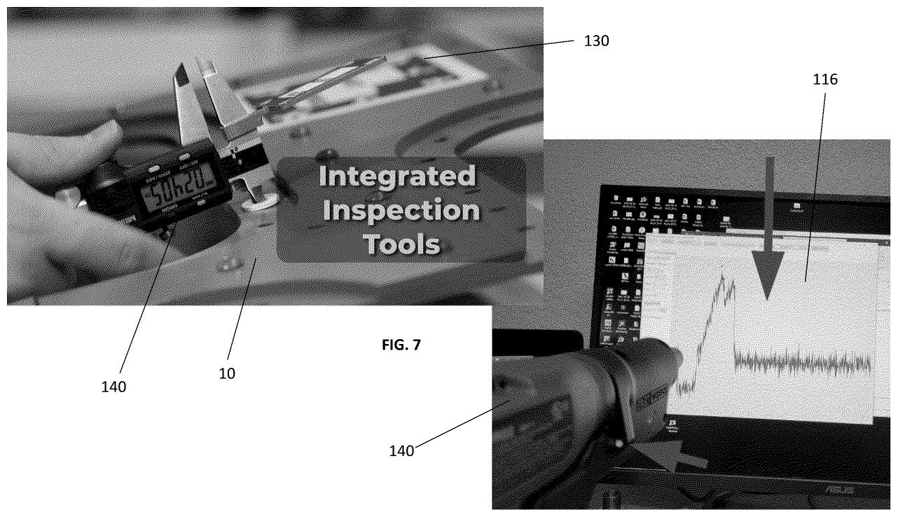

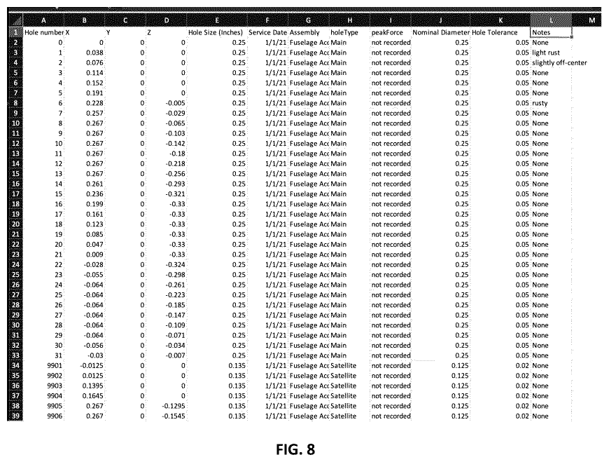

Tool 140 integration can, in some embodiments, provide additional information and functionality that can benefit the user during a task. For example, in some embodiments, the at least one processor 114 can automatically obtain, from the one or more tools 140, information concerning an operation performed by the tool 140 in connection with the one or more identified landmarks 12. With reference to FIG. 6, FIG. 7 and FIG. 8, tool 140 may be configured to collect and transmit certain data to XR system 120 and/or server 110 for overlay on the XR display 122 and/or terminal 116, in some cases in combination with other information from other sources such as database 118. Here, the tool 140 is being used to install fasteners in holes in part 10 and information 144 includes information from tool 140 such as initial measured diameter of the hole, peak force applied when installing the fastener, and post-repair hole diameter. In some embodiments, the at least one processor 114 can access the database 118 to obtain one or more images of the tool 140 and compare the one or more obtained images of the tool 140 to one or more images captured by the camera 124 to identify a tool present in the one or more images.

In some embodiments, the at least one processor 114 can automatically associate the information concerning the operation performed by the tool 140 with the identified landmark 12 on which the operation was performed. For example, the at least one processor 114 can, in some embodiments, store the tool 140, the operation performed by the tool 140, the landmark 12 the operation was completed on, or some combination thereof within the database 118 to associate this stored information. In some embodiments, to obtain the operation performed by the tool 140, the at least one processor 114 can establish a signal connection with the identified tool 140 based on the optical tracker 142 or fiducial 130 on the tool 140, such that the signal connection is suitable for at least receiving information transmitted by the identified tool 140.

The information transmitted by the identified tool 140 to the at least one processor 114 can, in some embodiments, include a time stamp corresponding to when the operation by the identified tool 140 was performed. Based on the time stamp from the identified tool 140, the at least one processor 114 can determine a location of the tool 140 in the one or more images captured by the camera(s) 124 at the time indicated by the received time stamp. The at least one processor 114 can be configured to compare the determined location of the tool 140 to a location of the one or more landmarks 12 identified in the one or more images captured by the camera 124 at the time indicated by the received time stamp to determine the identified landmark on which the tool was performing the operation.

To connect the landmark 12 with the tool 140 and the operation performed by the tool 140, the at least one processor 114 can, in some embodiments, automatically associate the information concerning the operation performed by the tool with the identified landmark on which the operation was performed by detecting, in the one or more images captured by the camera(s) 124, the operation being performed using the tool. The at least one processor 114 can determine, either upon such detection or based on a time stamp generated in connection with such detection, a location of the tool 140 in the one or more images captured by the camera at the time the operation was performed. To identify which landmark is associated with the operation, the at least one processor 114 can compare the determined location of the tool 140 to a location of the one or more landmarks 12 identified in the one or more images captured by the camera 124 at the time the operation was performed to determine the identified landmark 12 on which the tool was performing the operation.

In some embodiments, the at least one processor 114 can determine whether any of the information concerning the operation performed by the tool 140 exceeds a corresponding predetermined threshold associated with the operation. In some embodiments, the predetermined threshold associated with the operation depends, at least in part, on an evaluation of the state of the landmark 12 conducted prior to performing the operation. For example, the evaluation of the state of the landmark 12 conducted prior to performing the operation can include measuring an inner diameter of the landmark 12, e.g., a hole, and the predetermined threshold associated with the operation is a maximum degree of expansion associated with a maximum permissible hole diameter.

### Automatically Locating Landmarks 12

We now have a real-time implementation of the computer vision-based algorithm for locating landmarks 12 (e.g., holes) on the parts 10. This algorithm can, in some embodiments, work in two modes.

In a first mode, a database 118 of information concerning landmarks 12 previously associated with the part 10 is available. The database 118, in some embodiments, can include, for example, information regarding the number, types, locations, sizes, presence, other aspects, or some combination thereof, of each landmark 12. In some embodiments, this information may have been previously captured and stored during a prior use of system 100 (e.g., during installation or a prior maintenance/repair/inspection). In some embodiments, this information may have been acquired (e.g., via optical scan) from other digital or physical records, such as design and production drawings.

In some embodiments, the database 118 of information for that part 10 can be called based on scanning a unique identifier 132 previously affixed to and associated with the part 10. For example, a unique identifier 132 may have been affixed to the part and electronically associated with that part in the database, either during production of the part 10 or during a previous maintenance task performed on the part 10. Scanning can include any method known in the art for identifying the unique identifier 132, such as an optical scan of a barcode or fiducial 130 or by using the computer vision to identify the unique identifier 132. In some embodiments, the part 10 can be identified using computer vision to recognize the specific pattern of holes or other features or landmarks 12 on the part, either from a previous scan of the part 10 during a prior maintenance action or via a CAD model from the production stage of the part 10. This approach is particularly useful if a fiducial 130 or other part identifier is inaccessible (e.g., has been hidden from view during assembly or painting or has been damaged or removed from the part).

In some embodiments, the at least one processor 114 can analyze and identify the arrangement of landmarks 12 on the specific structural part 10 and compare the identified arrangement to those shown in images of structural parts 10 stored in a database 118 to identify a match. In this mode, server 110, or at least one processor 114, can first compare (i) landmark information stored in the landmark database in association with the part 10 with (ii) similar information derived by the computer vision algorithms as applied to images of the part 10 as captured by XR device 120, in order to identify whether there are differences between the two. In some embodiments, the at least one processor 114 can analyze the differences and present the differences to the technician.

One reason to compare the differences between the stored information about a particular landmark 12 can be to update the landmark 12 information stored in the landmark 12 database 118 for the part 10 to account for changes introduced since the landmark 12 information was last collected. For example, there may be differences if intermediate work has been done on part 10 or if part 10 was damaged since landmark 12 information was last collected. In such cases, the computer vision can identify additional landmarks 12, missing landmarks 12, and/or changes to prior stored landmarks 12. To the extent differences are identified, server 110 may automatically update the corresponding information stored in the landmark database to be consistent with that derived from images captured by XR device 120.

Another reason to compare the differences between the stored information about a particular landmark 12 so is to help calibrate XR system 120. For example, if only minor differences are detected (e.g., a minor shift in location of the landmarks between the previously stored information and the current computer vision-generated information), server 110 may recalibrate the XR display to account for such minor differences.

Yet another reason to compare the differences between the stored information about a particular landmark 12 can be to assist the computer vision in determining whether something shown in the captured imagery is a landmark 12 and/or determine characteristics thereof. For example, if the computer vision detects a possible landmark 12 but has a low level of certainty as to whether it really is a landmark 12, server 110 might determine that it is or is not a landmark 12 based on whether the stored information shows a landmark 12 at that location. In other words, if the computer vision is uncertain, server 110 might decide that it is in fact a landmark 12 if the stored information shows a landmark 12 at that location; conversely, server 110 might decide that it is not in fact a landmark 12 if the stored information does not show a landmark 12 at that location. In some embodiments, the server 110 can be configured to flag these instances for further review and verification by a user as well.

In a second mode, representative of a “cold start” condition, no existing landmark database is available for part 10 and thus the user is beginning work on a part 10 based solely on computer vision identification of landmarks 12 in (or on) part 10. This is perfectly feasible with quality computer vision and landmark information can be stored and used via the first mode when performing in the future.

In either mode, as the user performs the task (e.g., installation, maintenance, repair, inspection, etc.) on the part 10, the landmark location algorithm executed by server 110 (or, in an alternative embodiment, locally on XR system 120) can be used in concert with optical tracking of fiducial 130 to maintain high resolution awareness of the respective positions of XR system 120 and tool 140 (if used) relative to the part 10 (and the landmarks 12 thereon). Such functionality is critical for XR applications. The user experience component that utilizes this functionality is described in more detail below. In some embodiments, a 3D CAD model associated with the part (e.g., that used in production of the part) and/or model generated from prior maintenance tasks using the system can also be overlaid in the XR field of view. Doing so can help a user recognize potentially hidden landmarks 12 (e.g., painted over or hidden under other structure) or to recognize that a landmark 12 called for during production is missing or was never created. Doing so can also help users identify when a model is out of date. In some embodiments, throughout the present disclosure, the system 100 may be configured to automatically document measurements and other information collected during the inspection or maintenance task in association with the part 10, along with a date/time stamp and other information which may be useful for a particular application.

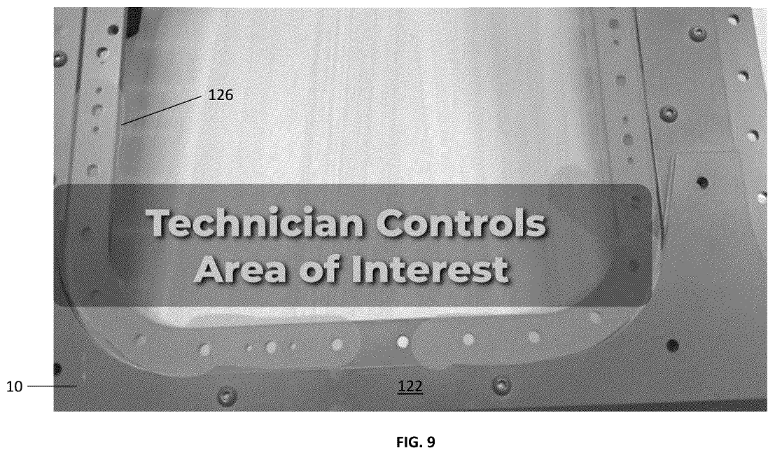

In some embodiments, a user may define one or more areas on which to focus (or, additionally or alternatively, not to focus) within the field of view of the camera(s) 124 used for landmark 12 recognition, so as to reduce the time and computational resources required for the computer vision tasks described herein. In some embodiments, the at least one processor 114 can receive from a user interface associated with the display a user input defining one or more portions of the structural part 10 in which to automatically identify the one or more landmarks 12. For example, as shown in FIG. 9, a user may use his or her finger to “paint” on a touchscreen of display 122 boundaries 126 around areas on part 10 that should be focused on (and/or ignored) by the computer vision algorithms based on the task at hand. This way time and resources are not spent trying to identify irrelevant landmarks 12 on part 10.

The present disclosure is further directed to a method for training the computer vision algorithm to recognize landmarks 12 with accuracy and precision. This can be particularly difficult when landmarks 12 create shadows and/or are obscured by shadows cast by other features of part 10. For example, in embodiments where landmark 12 is a hole, there is a tendency for at least a portion of the inner surface of the hole to be obscured by a shadow cast by surrounding portions of part 10 when a light source is not positioned and oriented orthogonal to the plane of the hole. In other words, if a light source is off to the right of a particular hole, the portion of part 10 surrounding the right side of the hole may obscure some of the light and thus cast a shadow onto the left inner surface of the hole, and vice versa. Shadows can not only make it difficult for computer vision algorithms to identify features, but also to identify the boundaries of such features with precision—e.g., the precise diameter of the hole. Such precision can be very important to the applications described herein (as well as in other applications, as one having ordinary skill in the art will recognize). In some embodiments, these issues may be overcome by training the computer vision algorithm using images of landmarks 12 taken from many different angles and many different lighting conditions (including, without limitation, lighting placements, lighting angles, lighting brightness, etc.). This can help the computer vision algorithm recognize such features despite shadows. In some embodiments, such training may further include identifying, for the computer vision model, associated measurement and other parameters of the landmark 12 shown in each training image. This can help the computer vision algorithm precisely identify such parameters of landmarks 12 in operation. In some embodiments, such training may further include identifying, for the computer vision model, the boundaries of the landmark 12 shown in each training image. For example, one might trace the boundaries of a hole in part 10—and, in particular, those portions obscured by shadows (e.g., the lower left edge of the hole, which is obscured by shadow in the example provided above)—so as to train the computer vision algorithm to recognize such contours despite being obscured by shadow. In some embodiments, such training may further include identifying, for the computer vision model, the angle of the camera used to capture the training image relative to the landmark 12, the distance of the camera from landmark 12, and/or the position/orientation of the light source relative to landmark 12. As configured, the computer vision algorithms can leverage inertial information (e.g., position and orientation) of XR system 120 to predict what the landmark 12 might look like from such position and orientation and thereby better identify such landmarks 12 (and parameters thereof) with fewer false positives/negatives.

### Automatically Evaluating Landmarks 12

In some embodiments, computer vision-based algorithms may be used to further evaluate landmarks 12, including measuring various geometric parameters of landmarks 12 (e.g., eccentricity, circularity, roundness hole dimensions, edge distance) and/or assessing various optical characteristics of landmarks 12 (e.g., coloration, reflectivity), and determining, based at least in part on those evaluations, whether further action is necessary (e.g., a maintenance or repair task). In some embodiments, the at least one processor 114 can automatically evaluate the state of the one or more landmarks 12 by measuring, in the one or more images captured by the camera 124, at least one parameter of the one or more identified landmarks 12.

For example, consider a scenario where the landmark 12 is a hole for receiving a fastener. In some embodiments, the one or more measured parameters includes an eccentricity of the hole (i.e., is it still relatively round or has it become ovate in response to applied stresses and strains), circularity or roundness (i.e., how closely the shape approaches a perfect circle), an internal diameter of the hole, distance from a center of the hole to an edge of the structural part 10, distance between the edges of two holes, hole pitch (i.e., distance between centers of two holes), or some combination thereof. In some embodiments, a high circularity or roundness can be a shape closer to being a perfect circle. In some embodiments, a low circularity or roundness can be a shape deviating significantly from a circle. Measuring circularity can, in some embodiments, permit measuring of corrosion wear and cracks that can impact circularity.

As another example, consider a scenario where the landmark 12 is a fastener. In some embodiments, the one or more measured parameters may include the coloration, reflectivity, or other optically-based parameters of the fastener. Such parameters may indicate whether the fastener material has oxidized or suffered from corrosion, for example. Likewise, coloration and/or reflectivity may be used to determine what material the fastener is made from and, in turn, allow the system 100 to determine the prescribed maintenance/inspection schedule in connection therewith. Such information could also be used to determine whether the correct fastener was used in the first place.

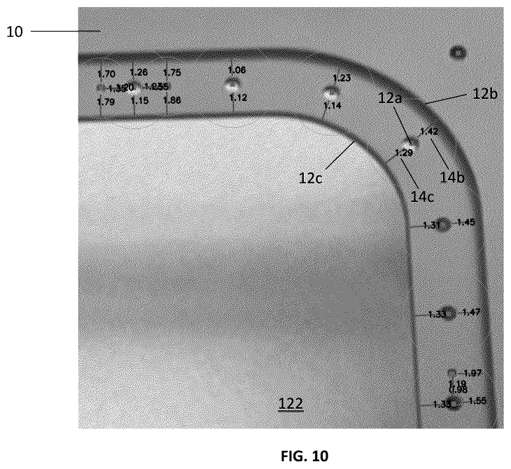

FIG. 10 illustrates a representative embodiment of certain evaluations, as displayed on display 122 of XR system 120. Here, part 10 is a door panel having a cutout for a window. The cutout is surrounded by a recessed border area defined by outer edge 12b and inner edge 12c, with various holes 12a configured to receive fasteners for attaching the window. Computer vision-based algorithms have identified these landmarks 12, (i.e., holes to receive fasteners) and further evaluated them by measuring a tearout distance and/or calculating edge distance. Tearout distance is the distance between the edge of a hole 12a and a corresponding edge of the part 10 (e.g., outer edge 12b and inner edge 12c). Edge distance, or “e/D”, is the corresponding ratio of (i) the distance from the center of each hole to the nearest edge and (ii) the diameter of that hole. In some embodiments, the at least one processor 114 may measure (i) and (ii) and calculate the edge distance of the hole as the ratio of (i) over (ii). Edge distance can also be thought of as tearout distance plus the radius of the hole. The hole 12a at issue has tearout distance 14b of 1.42 relative to edge 12b and a tearout distance 14c of 1.29 relative to edge 12c. In various applications, edge distance 14c may be considered more critical, since it is a distance to a free edge (i.e., edge 12c) and thus a possible tearout concern, whereas edge distance 14b is a distance to a step in material thickness. These measurements are overlaid on display 122 for consideration by the technician. The green circles shown around each hole represent edge distances of about 1.5, and about 2.5 and, in an embodiment, may also be displayed on display 122 for consideration by the technician.

In some embodiments, the information concerning the evaluated state of the one or more identified landmarks 12 for assisting a user of the display 122 in performing the inspection of the structural part 10 includes overlaying the information on a transparent screen, e.g., of a mobile device, such that the overlaid information is positioned over or proximate to each corresponding landmark 12 in the user's field of view. In some embodiments, the information concerning the evaluated state of the one or more identified landmarks 12 for assisting a user of the display 122 in performing the inspection of the structural part 10 includes overlaying the information on a real-time image captured by the camera 124 such that the overlaid information is positioned over or proximate to each corresponding landmark 12 in the real-time image. In some embodiments, the at least one processor 114 can be configured to present, on the display 122, the information concerning the operation performed by the tool 140 for assisting a user of the display 122 in performing one or more installation, maintenance, repair, or inspection tasks on the structural part 10. In some embodiments, the presenting by the at least one processor 114 includes overlaying the information concerning the operation performed by the tool 140 on a transparent screen, e.g., of a mobile device, such that the overlaid information is positioned over or proximate to the identified landmark on which the operation was performed in the user's field of view. In some embodiments, the presenting by the at least one processor 114 includes overlaying the information concerning the operation performed by the tool 140 on a real-time image captured by the camera 124, such that the overlaid information is positioned over or proximate to the identified landmark on which the operation was performed in the real-time image. In some embodiments, the at least one processor 114 can display a visual indicator as to whether any of the information concerning the operation performed by the tool 140 exceeds the associated predetermined threshold(s) (described below).

In some embodiments, system 100 may be configured to further evaluate measurements to determine, for example, if they are within acceptable standards or ranges or otherwise out-of-spec. In an embodiment, the thresholds may be stored in database 118 and called by server 110 and/or XR system 120 to perform such a comparison. In such cases, comparing landmark 12 information stored in the landmark database in association with the part 10 with similar information derived by the computer vision algorithms as applied to images of the part 10 as captured by XR system 120 can detect such deviations from accepted edge distance standards and flag them for the user. In the current example, repeated coldworking of holes 12a can expand the size of the holes 12a in such a way that the hole 12a get closer to edges 12b, 12c. If one or both of these edge distances 14b, 14c becomes too small the hole may be at risk of tearing open, at which point part 10 may need to be repaired or replaced. Likewise, a hole may be erroneously placed too close to the part edge during production. In various embodiments, system 100 may compare edge distances 14b, 14c to predetermined minimum thresholds and alert the technician if such thresholds are exceeded. In the aforementioned scenario where the landmark 12 is a hole for receiving a fastener, the determined threshold(s) may be a maximum eccentricity, a minimum circularity or roundness, maximum hole diameter, a minimum edge distance, or a combination thereof. In the aforementioned scenario where the landmark 12 is a fastener, the determined threshold(s) may be a maximum shade of coloration or patina, a maximum or minimum reflectivity associated with a particular material, or a combination thereof. In another a scenario where the landmark 12 is a fastener to be installed in a hole in structural part 10, and tool 140 is used to expand the fastener within the hole in the structural part, system 100 may (i) evaluate the state of the fastener prior to performing the operation (e.g., measuring an inner diameter of the fastener) and (ii) measure the state of the fastener after performing the operation (e.g., measuring the inner diameter of the fastener to calculate the degree of expansion). In this scenario, the predetermined thresholds associated with the operation may include: (i) a minimum degree of expansion associated with securely installing the fastener (i.e., the fastener needs to be expanded enough to form a friction, mechanical, and/or adhesive fit with an inner surface of the hole and (ii) a maximum degree of expansion associated with maintaining structural integrity of the fastener (i.e., not be expanded so far as to weaken the fastener beyond an acceptable tolerance, or even tear the fastener).

In some embodiments, XR system 120 can be configured to change the color of lines overlaid on the landmark at issue, such as changing the circle shown around the edge of an out-of-spec hole from green to red. A representative minimum edge distance threshold may be e/D=1.8; if edge distance calculation is greater than this threshold the line remains green but if edge distance calculation is less than this threshold the line turns red. One having ordinary skill in the art will recognize that these principles can be applied to other example applications, albeit perhaps using different measurements/calculations and different comparisons.

Various tools and approaches may be used to enhance the accuracy and precision of computer vision-based measurements:

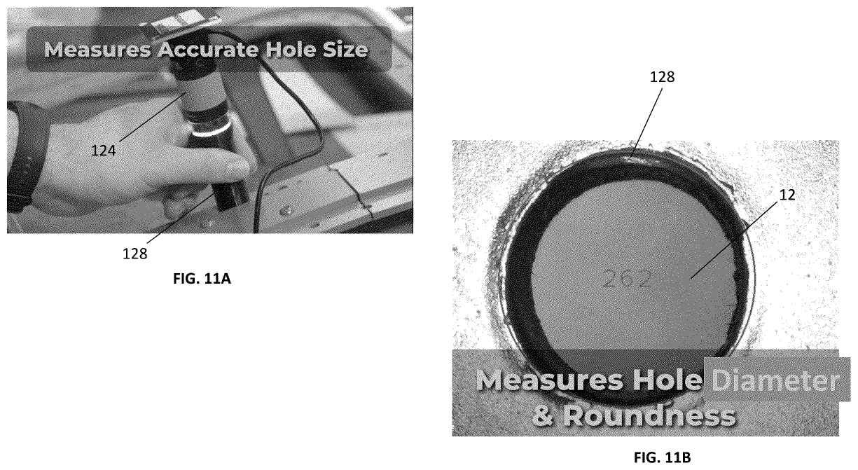

FIG. 11A and FIG. 11B illustrates a camera 124 having a rigid tube structure 128 protruding forward of the lens. In operation, a distal end of the rigid tube structure 128 is placed flush against a surface of part 10 such that camera 124 is positioned at a known distance from the surface and at a known angle relative thereto. Causing the camera 124 to be positioned and oriented in this manner provides scale that allows the computer vision to better determine the precise dimensions of landmarks 12 shown in the images captured by camera 124.

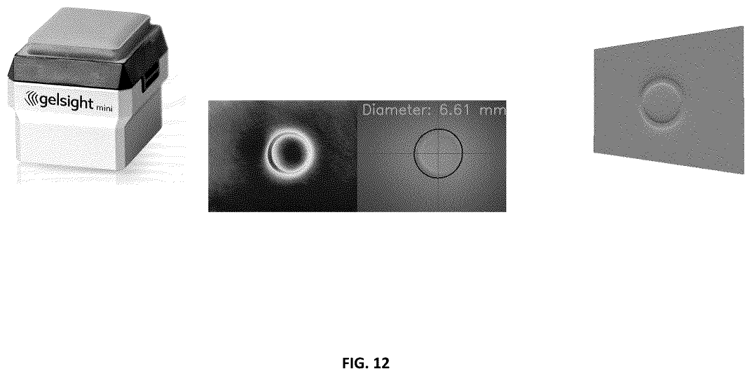

FIG. 12 illustrates an elastomeric platform that creates a soft, high-resolution, tactile sensor that conforms to the shape of an object on contact, precisely capturing the topography of the surface.

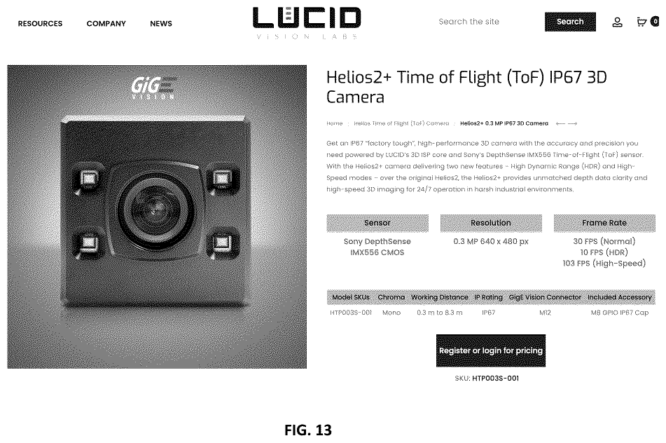

FIG. 13 illustrates a type of 3D camera known as a time-of-flight (ToF) camera. They capture depth information by measuring the time it takes for light to travel from the camera to the surface and back. This allows ToF cameras to create a depth map of a scene, which can then be used to reconstruct 3D surfaces, such as countersunk holes.

Side lighting can enhance depth detection in augmented reality (AR) by emphasizing surface textures and contours. When light hits an object from the side, it casts shadows and highlights that accentuate the 3D features of the surface. Here's how side lighting can help improve depth detection for a camera in AR:
1. Enhancing Surface Details: Side lighting creates contrasts on the surface by casting shadows in recessed areas and highlights on raised parts. This effect makes it easier for the camera to detect subtle changes in depth, as the light emphasizes edges, textures, and contours. In AR, this helps the camera better understand the structure of the scene.
2. Improving Feature Detection: AR systems often rely on feature points to understand and map a scene. Side lighting accentuates these features by increasing the contrast between different parts of the object, which allows the camera to identify more unique points. More feature points can improve the accuracy and stability of depth mapping and tracking.
3. Supporting Depth Estimation Algorithms: Many depth estimation algorithms in AR use cues like shading, texture gradients, and occlusion to infer depth. Side lighting naturally enhances these cues, providing clearer data for the algorithms to analyze. For example, the light's interaction with surfaces can reveal subtle depth cues that might not be apparent under flat, uniform lighting.
4. Facilitating Edge Detection: The strong contrasts created by side lighting can make it easier for edge-detection algorithms to identify the boundaries and edges of objects. This is particularly helpful when trying to differentiate between objects in a cluttered scene, as the lighting highlights where one object ends, and another begins, adding depth and dimension to the scene.

Using multiple cameras for stereo photogrammetry provides detailed depth information and allows for the creation of accurate 3D models. It is commonly used in various fields, such as surveying, architecture, and AR/VR, where precise 3D reconstructions are essential. In photogrammetry, two or more cameras can be used to create a stereo vision system, which allows for depth estimation by analyzing differences between images taken from slightly different perspectives. This process is similar to how human eyes perceive depth. Here's how multiple cameras work together for depth estimation in photogrammetry:
1. Capturing Stereo Images: Two cameras are positioned at a fixed distance apart, often referred to as the baseline. When these cameras capture images of the same scene, each camera provides a slightly different perspective. The closer the object is to the cameras, the greater the difference between the two images, which is known as parallax.
2. Matching Key Points: Photogrammetry software identifies corresponding points (key points) in both images. These points are typically features like corners, edges, or unique textures that are easily identifiable from both perspectives. The software then matches these key points across the stereo images.
3. Calculating Disparity: Once corresponding points are matched, the software calculates the disparity, which is the difference in the position of these points between the two images. The disparity is directly related to the distance of the points from the cameras: larger disparities indicate closer objects, while smaller disparities indicate objects that are farther away.
4. Triangulation for Depth Calculation: Using the disparity and the known distance between the cameras (baseline), the software employs triangulation to calculate the depth (or distance) of each point from the cameras. Essentially, it uses the geometry of the camera setup to determine the 3D coordinates of each point in space relative to the cameras.
5. Reconstructing the 3D Surface: With depth information from numerous points across the scene, the software reconstructs the 3D surface by creating a dense point cloud. This point cloud represents the depth and shape of the entire scene, which can then be used to build a 3D model.
6. Enhancing Accuracy with Multiple Cameras: Adding more cameras can improve the accuracy and robustness of the depth estimation. With three or more cameras, the system can capture more perspectives, which provides additional parallax information. This can be especially helpful in complex scenes or when certain areas are partially occluded from one camera's view.

### Methods of Use

To illustrate the concepts described herein, according to some embodiments, the following can be a representative repair scenario. The user experience prototype has been divided into two separate user interfaces which integrates the functionality of the automated hole location and the tool tracking subsystems. The first prototype is focused on supporting the repair scenario and utilizes a tablet. The second prototype uses a head-mounted display (e.g., MagicLeap 2 Augmented Reality goggles) and is focused on supporting inspection scenarios.

Below are the steps in a representative repair scenario:
Step 1a: Hole location and registration (“cold start” version):
   1. The User sees live video on the tablet with augmentations registered with the physical part 10, including a virtual coordinate system overlaid on the fiducial which is attached to the part for tracking. On the screen is a HUD that displays text with information on a currently selected hole. There are onscreen buttons for accessing different modes including a set of controls for manual control of hole information (“add hole”, “remove hole”, and buttons for translating button position).
   2. The computer vision algorithm identifies potential holes in the scene and augments them via registered virtual highlights of a neutral color.
   3. The initial data on 3D hole locations is created and that information is saved to the database. Real-time tracking is active and therefore virtual holes will remain registered with the physical part as the tablet is moved.
Step 1b: Hole location and registration (with existing hole data):
1. the User sees physical holes on the part with virtual holes overlaid from existing database.
2. The automated hole location algorithm locates physical holes and attempts to align the virtual holes from the database with what it finds. Holes with discrepancy (e.g., holes with offsets versus the physical hole or hole that is not in database) are highlighted in red.
3. The User selects the virtual error holes and indicates to the system what correction is needed (e.g. “add new hole to database”, “remove hole from database”, “snap to hole”).
Step 2: Hole Gauge Measurement:
1. The User is now ready to begin work. They will start by taking measurements of hole size. The user picks up the hole gauge tool and brings it into view of the camera 124. A virtual highlight appears around the marker on the hole gauge to indicate that tracking is active and is aligned with the physical tool.
   2. The User inserts the tool into a hole. The hole has a noticeable highlight to indicate which one is currently selected. The HUD populates with data about that hole and its ID.
   3. The User presses a button on the hole gauge to take a measurement. That value in inches is shown in the “Hole Gauge Reading” field.
   4. The User can continue to measure the holes on the part 10. If a measurement is taken that reveals the diameter to be outside the acceptable range, a red highlight appears around the physical hole. All hole measurement data is saved to the database.
Step 3: Perform Repair:
   1. User sees the virtual holes of the neutral color registered with the physical part. Holes that have been identified as needing repair are highlighted in red.
   2. User selects a hole that needs repair and the measured diameter is displayed along with a recommended parts list.
   3. User brings the mandrel bag and drill bit into view of the device. The system recognizes an optical code on them and will indicate visually through augmentations and the HUD whether it is the correct bag.
   4. Then, the User picks up the mandrel tool and brings it into view of the iPad. A virtual highlight appears around the marker on the tool to indicate that tracking is active and aligned with the physical tool.
   5. The User places the tool tip into/near a hole. The system detects whether they are about to perform the repair on the correct hole. If not, the User is warned of their error.
   6. When the correct hole is selected hole the User is instructed to proceed and the Heads Up Display (HUD) populates with data for selected hole.
   7. The User performs the repair. When they remove the puller from hole, data from repair is shown in HUD and as a visualization registered with the physical hole.
Step 4: Measure Hole Diameter After Repair: The User repeats the hole measurement steps from before and the HUD reflects measurements from before and after the repair. The text is color coded to indicate if there are error conditions (e.g. hole size too large/small based on wrong mandrel size being used for the repair).

Below are the steps in a representative repair scenario utilizing a head-mounted display (HMD) to display real-time augmentations to an inspector:
1. The User dons the HMD and picks up the controller in their dominant hand. They see the virtual coordinate system on top of the fiducial marker mounted on the part. A small ray protrudes from the physical controller to support selection. As before, the virtual holes from the database 118 populate the scene, registered with the physical holes. Color highlights indicate the status of holes (e.g. repaired, in need of repair, measurements outside of acceptable range etc.) to guide the User to inspect those holes.
2. User moves controller toward a hole to select it. When the short virtual ray is near a hole, it is virtually highlighted. The user presses the trigger to lock in the selection.
3. Hole data appears as text in the HUD and visual data such as the DIC “heat map” collected during the cold working process, appears registered with the hole.

What is claimed is:

1. A system for facilitating the inspection of a structural part, the system comprising:
a processor; and
a non-transitory memory containing computer-readable instructions that, when executed by the processor, causes the processor to:
automatically identify, in one or more images captured by a camera, one or more landmarks on a structural part;
automatically evaluate a state of the one or more identified landmarks; and
present, on a display, information concerning the evaluated state of the one or more identified landmarks for assisting a user of the display in performing an inspection of the structural part.

2. The system of claim 1, wherein the one or more landmarks on the structural part comprise at least one of a structural component of the structural part, a geometric shape on the structural part, contours of the structural part, edges of the structural part, visual indicia of damage to the structural part, fasteners installed in the structural part, and holes in the structural part for receiving fasteners.

3. The system of claim 1, wherein automatically identifying the one or more landmarks on the structural part comprises the processor:
obtaining, from a database, an identification and corresponding location of landmark(s) stored in the database in association with the specific structural part;
processing a portion(s) of the one or more images captured by the camera corresponding to the location(s) to determine whether the landmark(s) is present in those portions.

4. The system of claim 3, wherein processing the portion(s) of the one or more images captured by the camera corresponding to the location(s) to determine whether the landmark(s) is present in those portions comprises the processor:
obtaining, from the database, one or more stored images of the specific structural part having the identified landmarks at the obtained locations; and
comparing portions of the obtained image(s) to the corresponding portions of the one or more images captured by the camera.

5. The system of claim 3, wherein processing the portion(s) of the one or more images captured by the camera corresponding to the location(s) to determine whether the landmark(s) is present in those portions comprises the processor:
obtaining, from the database, one or more stored images of the type(s) of landmark(s) identified as being associated with the specific structural part; and
comparing the one or more obtained images of the type(s) of landmark(s) to portions of the one or more images captured by the camera to identify whether landmarks of the same type are present in the portions.

6. The system of claim 3, wherein obtaining, from the database, the identification and corresponding location of landmark(s) stored in the database in association with the specific structural part comprises the processor processing the one or more images captured by the camera to locate a unique identifier affixed to and associated with the specific structural part.

7. The system of claim 3, wherein obtaining, from the database, the identification and corresponding location of landmark(s) stored in the database in association with the specific structural part comprises identifying an arrangement of landmarks on the specific structural part and comparing the identified arrangement to those shown in images of structural parts stored in the database to identify a match.

8. The system of claim 3, wherein the processor is further configured to automatically store, in the database in association with the specific structural part, at least one of a type, location, and presence of the one or more landmarks on the structural part as identified.

9. The system of claim 1, wherein automatically identifying the one or more landmarks on the structural part comprises the processor:
receiving, from one or more sensors associated with the camera, information concerning an orientation of the camera and a distance of the camera from the structural part for each image captured by the camera;
identifying, in a database of images, those database images which were captured from the same or similar orientation and distance as those of the one or more images captured by the camera; and
comparing the one or more images captured by the camera to the identified database images to identify the one or more landmarks.

10. The system of claim 9, further comprising the processor:
identifying, in the one or more images captured by the camera, a fiducial affixed to the structural part;
retrieving, from a database, dimensions of the identified fiducial; and
using the retrieved dimensions of the fiducial as a reference to determine the distance of the camera from the structural part.

11. The system of claim 1, wherein automatically identifying the one or more landmarks on the structural part comprises the processor:
causing the display to display the one or more images captured by the camera; and
receiving, from a user interface associated with the display, user input defining one or more portions of the structural part in which to automatically identify the one or more landmarks.

12. The system of claim 1, wherein automatically evaluating the state of the one or more identified landmarks comprises the processor measuring, in the one or more images captured by the camera, at least one parameter of the one or more identified landmarks.

13. The system of claim 12, wherein automatically evaluating the state of the one or more identified landmarks further comprises the processor determining whether any of the one or more measured parameters of the landmark exceed a predetermined threshold or thresholds associated with the landmark.

14. The system of claim 13,
wherein the landmark is a hole for receiving a fastener;
wherein the one or more measured parameters comprise an internal diameter of the hole; and
wherein the predetermined threshold is a maximum hole diameter.

15. The system of claim 13,
wherein the landmark is a hole for receiving a fastener;
wherein the one or more measured parameters comprise: (i) a distance from a center of the hole to an edge of the structural part, and (ii) an internal diameter of the hole;
further comprising the processor calculating an edge distance of the hole as the ratio of (i) over (ii); and
wherein the predetermined threshold is a minimum edge distance.

16. The system of claim 13, further comprising the processor:
identifying, in the one or more images captured by the camera, a fiducial affixed to the structural part;
retrieving, from a database, dimensions of the identified fiducial; and
using the retrieved dimensions of the fiducial as a reference to determine the one or more dimensions of the identified landmark and/or the distance of the identified landmark from other landmarks on the structural part.

17. The system of claim 13, wherein the processor is further configured to automatically store, in the database in association with the specific structural part, the information concerning the evaluated state of the one or more landmarks.

18. The system of claim 1, wherein presenting, on the display, information concerning the evaluated state of the one or more identified landmarks for assisting a user of the display in performing the inspection of the structural part comprises overlaying the information on a transparent screen of a mobile device such that the overlaid information is positioned over or proximate to each corresponding landmark in the user's field of view.

19. The system of claim 1, wherein presenting, on the display, information concerning the evaluated state of the one or more identified landmarks for assisting a user of the display in performing the inspection of the structural part comprises overlaying the information on a real-time image captured by the camera such that the overlaid information is positioned over or proximate to each corresponding landmark in the real-time image.

20. The system of claim 13, wherein presenting, on the display, information concerning the evaluated state of the one or more identified landmarks for assisting a user of the display in performing the inspection of the structural part the structural part comprises displaying a visual indicator as to whether one or more of the evaluated parameters exceeds the associated predetermined threshold.

21. A system for facilitating operations performed on a structural part, the system comprising:
a processor; and
a non-transitory memory containing computer-readable instructions that, when executed by the processor, causes the processor to:
automatically identify, in one or more images captured by a camera:
one or more landmarks on a structural part; and
a tool;
automatically obtain, from the tool, information concerning an operation performed by the tool in connection with the one or more identified landmarks; and
automatically associate the information concerning the operation performed by the tool with the identified landmark on which the operation was performed.

22. The system of claim 21, wherein the one or more landmarks on the structural part comprise at least one of a structural component of the structural part, a geometric shape on the structural part, contours of the structural part, edges of the structural part, visual indicia of damage to the structural part, fasteners installed in the structural part, and holes in the structural part for receiving fasteners.

23. The system of claim 21, wherein automatically identifying the one or more landmarks on the structural part comprises the processor:
obtaining, from a database, an identification and corresponding location of landmark(s) stored in the database in association with the specific structural part;
processing a portion(s) of the one or more images captured by the camera corresponding to the location(s) to determine whether the landmark(s) is present in those portions.

24. The system of claim 23, wherein processing the portion(s) of the one or more images captured by the camera corresponding to the location(s) to determine whether the landmark(s) is present in those portions comprises the processor:
obtaining, from the database, one or more stored images of the specific structural part having the identified landmarks at the obtained locations; and
comparing portions of the obtained image(s) to the corresponding portions of the one or more images captured by the camera.

25. The system of claim 23, wherein processing the portion(s) of the one or more images captured by the camera corresponding to the location(s) to determine whether the landmark(s) is present in those portions comprises the processor:
obtaining, from the database, one or more stored images of the type(s) of landmark(s) identified as being associated with the specific structural part; and
comparing the one or more obtained images of the type(s) of landmark(s) to portions of the one or more images captured by the camera to identify whether landmarks of the same type are present in the portions.

26. The system of claim 23, wherein obtaining, from the database, the identification and corresponding location of landmark(s) stored in the database in association with the specific structural part comprises the processor processing the one or more images captured by the camera to locate a unique identifier affixed to and associated with the specific structural part.

27. The system of claim 23, wherein obtaining, from the database, the identification and corresponding location of landmark(s) stored in the database in association with the specific structural part comprises identifying an arrangement of landmarks on the specific structural part and comparing the identified arrangement to those shown in images of structural parts stored in the database to identify a match.

28. The system of claim 23, wherein the processor is further configured to automatically store, in the database in association with the specific structural part, at least one of a type, location, and presence of the one or more landmarks on the structural part as identified.

29. The system of claim 21, wherein automatically identifying the one or more landmarks on the structural part comprises the processor:
receiving, from one or more sensors associated with the camera, information concerning an orientation of the camera and a distance of the camera from the structural part for each image captured by the camera;
identifying, in a database of images, those database images which were captured from the same or similar orientation and distance as those of the one or more images captured by the camera; and
comparing the one or more images captured by the camera to the identified database images to identify the one or more landmarks.

30. The system of claim 29, further comprising the processor:
identifying, in the one or more images captured by the camera, a fiducial affixed to the structural part;
retrieving, from a database, dimensions of the identified fiducial; and
using the retrieved dimensions of the fiducial as a reference to determine the distance of the camera from the structural part.

31. The system of claim 21, wherein automatically identifying the one or more landmarks on the structural part comprises the processor:
causing the display to display the one or more images captured by the camera; and
receiving, from a user interface associated with the display, user input defining one or more portions of the structural part in which to automatically identify the one or more landmarks.

32. The system of claim 21, wherein automatically identifying the tool comprises the processor:
obtaining, from the database, one or more stored images of tools;
comparing the one or more obtained images tools to the one or more images captured by the camera to identify a tool present in the one or more images.

33. The system of claim 21, wherein automatically identifying the tool comprises the processor processing the one or more images captured by the camera to locate a unique identifier affixed to and associated with the tool.

34. The system of claim 33, wherein automatically obtaining, from the one or more tools, information concerning an operation performed by the identified tool in connection with the one or more identified landmarks comprises the processor causing a receiver to establish a signal connection with the identified tool based on the unique identifier on the identified tool, the signal connection being suitable for at least receiving the information transmitted by the identified tool.

35. The system of claim 21, wherein automatically associating the information concerning the operation performed by the tool with the identified landmark on which the operation was performed comprises:
receiving, together with the obtained information regarding the operation performed by the tool, a time stamp corresponding to when the operation was performed;
determining, based on the received time stamp, a location of the tool in the one or more images captured by the camera at the time indicated by the received time stamp;
comparing the determined location of the tool to a location of the one or more landmarks identified in the one or more images captured by the camera at the time indicated by the received time stamp to determine the identified landmark on which the the tool was performing the operation.

36. The system of claim 33, wherein automatically associating the information concerning the operation performed by the tool with the identified landmark on which the operation was performed comprises:
detecting, in the one or more images captured by the camera, the operation being performed using the tool;
determining, either upon such detection or based on a time stamp generated in connection with such detection, a location of the tool in the one or more images captured by the camera at the time the operation was performed;
comparing the determined location of the tool to a location of the one or more landmarks identified in the one or more images captured by the camera at the time the operation was performed to determine the identified landmark on which the the tool was performing the operation.

37. The system of claim 21, wherein the processor is further configured to automatically store, in the database in association with the structural part, the information concerning the operation performed by the tool in association with the identified landmark on which the operation was performed.

38. The system of claim 21, further comprising the processor determining whether any of the information concerning the operation performed by the tool exceeds a corresponding predetermined threshold or thresholds associated with the operation.

39. The system of claim 38, wherein the predetermined threshold(s) associated with the operation depends at least in part on an evaluation of the state of the landmark conducted prior to performing the operation.

40. The system of claim 39,
wherein the landmark is a fastener to be installed in the structural part;
wherein the tool is a tool configured for expanding the fastener within a hole in the structural part;
wherein the evaluation of the state of the fastener conducted prior to performing the operation comprises measuring an inner diameter of the fastener; and
wherein the predetermined thresholds associated with the operation are (i) a minimum degree of expansion associated with securely installing the fastener and (ii) a maximum degree of expansion associated with maintaining structural integrity of the fastener.

41. The system of claim 21, the processor being further configured to present, on a display, the information concerning the operation performed by the tool for assisting a user of the display in performing one or more installation, maintenance, repair, or inspection tasks on the structural part

42. The system of claim 41, wherein presenting comprises overlaying the information concerning the operation performed by the tool on a transparent screen of a mobile device such that the overlaid information is positioned over or proximate to the identified landmark on which the operation was performed in the user's field of view.

43. The system of claim 21, wherein presenting comprises overlaying the information concerning the operation performed by the tool on a real-time image captured by the camera such that the overlaid information is positioned over or proximate to the identified landmark on which the operation was performed in the real-time image.

44. The system of claim 33, wherein presenting comprises displaying a visual indicator as to whether any of the information concerning the operation performed by the tool exceeds the associated predetermined threshold(s).

45. A system for facilitating the inspection of a structural part, the system comprising:
a processor; and
a non-transitory memory containing computer-readable instructions that, when executed by the processor, causes the processor to:
automatically determine a three-dimensional position and orientation of a camera relative to a structural part within a field of view of the camera;
automatically identify, in a two-dimensional image captured by the camera, one or more landmarks on the structural part, wherein automatically identifying the one or more landmarks comprises:
accessing, from a database of reference images, one or more reference images of reference landmarks which were captured from the same or similar relative three-dimensional position and orientation of the camera; and
identifying, in the two-dimensional image, one or more portions of the two-dimensional image matching at least one of the accessed reference images.
automatically evaluate a state of the one or more identified landmarks; and
present, on a display, information concerning the evaluated state of the one or more identified landmarks for assisting a user of the display in performing an inspection of the structural part, the presented information being overlaid on the one or more identified and evaluated landmarks shown in the two-dimensional image.

46. The system of claim 45, wherein the one or more landmarks on the structural part comprise at least one of a structural component of the structural part, a geometric shape on the structural part, contours of the structural part, edges of the structural part, visual indicia of damage to the structural part, fasteners installed in the structural part, and holes in the structural part for receiving fasteners.

47. The system of claim 45, wherein automatically determining the three-dimensional position and orientation of the camera relative to a structural part within a field of view of the camera comprises the processor:
identifying, in the two-dimensional image, a fiducial affixed to the structural part, the fiducial having a known size and shape; and
calculating, based on the known size and shape of the fiducial, the three-dimensional position and orientation of the camera relative to the structural part.

48. The system of claim 45, wherein automatically identifying the one or more landmarks on the structural part comprises the processor:
causing the display to display the two-dimensional image; and
receiving, from a user interface associated with the display, user input defining one or more portions of the structural part in which to automatically identify the one or more landmarks.

49. The system of claim 45, wherein automatically evaluating the state of the one or more identified landmarks includes the processor:
measuring, in the two-dimensional image captured by the camera, at least one parameter of the one or more identified landmarks; and
transforming the parameter measurement to account for the perspective of the camera based on the determined three-dimensional position and orientation of the camera relative to the structural part.

50. The system of claim 49, wherein transforming the measured parameter comprises:
deriving, from the determined position and orientation of the camera relative to the structural part, an angle at which the two-dimensional image was captured by the camera; and
calculating, based on the derived angle, a corresponding adjustment to the measured parameter.

51. The system of claim 49, wherein automatically evaluating the state of the one or more identified landmarks further comprises the processor determining whether any of the one or more measured parameters of the landmark, as transformed to account for the perspective of the camera, exceed a predetermined threshold associated with the landmark.

52. The system of claim 45, the non-transitory memory further comprising computer-readable instructions that, when executed by the processor, causes the processor to:
automatically identify a tool in the two-dimensional image;
automatically obtain, from tool, information concerning an operation performed by the tool in connection with the one or more identified landmarks; and
automatically associate the information concerning the operation performed by the tool with the identified landmark on which the operation was performed.

53. The system of claim 52, wherein automatically associating the information concerning the operation performed by the tool with the identified landmark on which the operation was performed comprises:
automatically determining a three-dimensional position and orientation of the tool relative to the structural part; and
identifying, based at least in part on the determined three-dimensional position and orientation of the tool relative to the structural part, the landmark with which the tool is interacting when performing the operation.

54. The system of claim 53, wherein automatically determining the three-dimensional position and orientation of the tool relative to the structural part comprises the processor:
identifying, in the two-dimensional image, a first fiducial affixed to the tool and a second fiducial affixed to the structural part, each of the first and second fiducials having a known size and shape; and
calculating, based on the known sizes and shapes of the first and second fiducials, the three-dimensional position and orientation of the tool relative to the structural part comprises the processor.
